(19) United States
(12) Patent Application Publication
(10) Pub. No.: US 2006/0206674 A1
(43) Pub. Date: Sep. 14, 2006

(54) OPTICAL DISC DRIVE AND PROGRAM CODE UPDATING METHOD THEREOF

(76) Inventor: Hui-Huang Chang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,566

(22) Filed: Jan. 3, 2006

(30) Foreign Application Priority Data
Jan. 4, 2005 (TW) 094100168

(51) Int. Cl. G06F 13/00

(52) U.S. Cl. 711/154

(57) ABSTRACT

An optical disc drive is disclosed. The optical disc drive includes a non-volatile memory storing a first program code; a memory providing a space needed when executing the first program code; and a control module determining whether to update the first program code stored in the non-volatile memory or not.

### BACKGROUND OF THE INVENTION

1. Field of the Invention

The present invention relates to an optical disc drive, and more specifically, to an optical disc drive whose firmware can be updated.

2. Description of the Prior Art

Optical disc drives are utilized for accessing data stored on an optical disc. A micro-controller contained in the optical disc drive uses a program code to manage resources of the optical disc drive or to control operations of the optical disc drive. The above-mentioned program code is usually called “a firmware”, which includes required data, command(s)/instruction(s), program(s), and other information utilized in the optical disc drive. In general, such a firmware is stored in a non-volatile memory of the optical disc drive. When an optical disc drive manufacturer designs an optical disc drive with extensible functions, the optical disc drive is usually designed so that its firmware can be updated.

A method according to a related art is to store the firmware and firmware updating routine in the non-volatile memory of a conventional optical disc drive. When the firmware needs to be updated, a micro-controller executes the stored firmware updating routine to update the firmware stored in the non-volatile memory. This related art method has some drawbacks, detailed as follows: firstly, it is necessary to design additional firmware updating routine(s), and secondly, the non-volatile memory of the optical disc drive needs additional memory space to store additional firmware updating routine(s); therefore available memory space becomes smaller.

U.S. Pat. No. 6,170,043 discloses a conventional optical disc drive whose firmware can be updated. One drawback of the conventional optical disc drive is that the additional memory space is usually idle, and it is necessary to use share circuits to utilize the above-mentioned additional idle memory space in order to avoid wasting resources.

Furthermore, the access speed of the non-volatile memory is slow, and when updating the program code, it is necessary to switch the source of the program code. Therefore, the above-mentioned methods are inefficient and complicated.

### SUMMARY OF THE INVENTION

One of the objectives of the claimed invention is to provide an optical disc drive and a firmware updating method, in order to make the optical disc drive efficiently utilize system resources no matter whether executing routine tasks or updating a firmware.

One of the objectives of the claimed invention is to provide an optical disc drive, in order to improve the speed of executing a program code.

One of the objectives of the claimed invention is to provide an optical disc drive, in order to reduce the required size of the non-volatile memory.

One of the objectives of the claimed invention is to provide an optical disc drive, in order to prevent the non-volatile memory from being damaged due to overuse.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an optical disc drive according to the present invention.

FIG. 2 is a flowchart of updating a program code of an optical disc drive according to the present invention.

FIG. 3 is a detailed flowchart of step 214 shown in FIG. 2.

### DETAILED DESCRIPTION

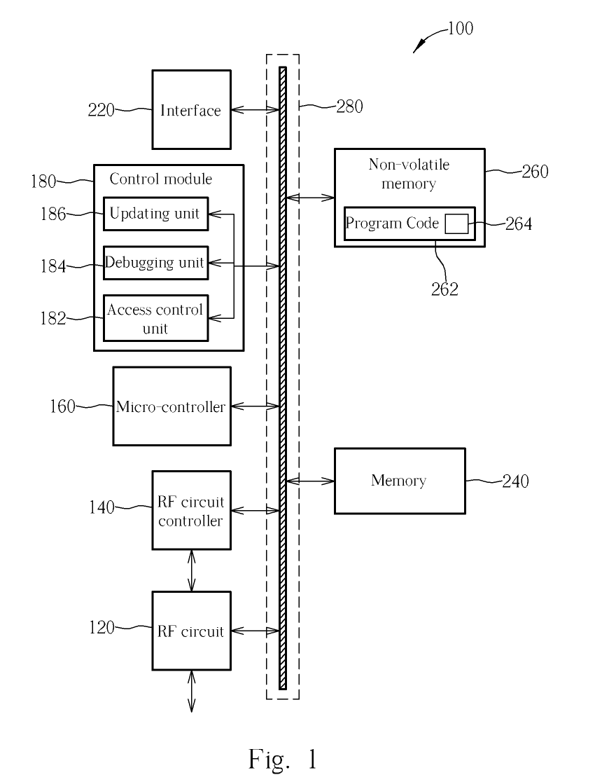

FIG. 1 is a block diagram of an optical disc drive 100 according to the present invention. The optical disc drive 100 comprises a radio frequency (RF) circuit 120, an RF circuit controller 140, a micro-controller 160, a control module 180, an interface 220, a memory 240, a non-volatile memory 260, and a bus 280. The non-volatile memory 260 comprises a memory block 262 for storing a program code P1, where the non-volatile memory 260 comprises memory block 264 for storing at least one parameter of the program code P1. The non-volatile memory 260 utilized in the optical disc drive 100 according to the present invention can be a flash memory, an erasable programmable read only memory (EEPROM) or some other non-volatile memory. The memory 240 can be a volatile memory, a static random access memory (SRAM), a dynamic random access memory (DRAM) or other equivalent memories. In a preferred embodiment of the present invention, the access speed of the memory 240 is greater than that of the non-volatile memory 260, allowing the executing speed of the firmware to be improved. In addition, the control module 180 further comprises an access control unit 182, a debugging unit 184 and an updating unit 186. Functions and structures of other devices, such as the RF circuit 120, the RF controller circuit 140, the micro-processor 160, the interface 220 and the bus 280, are well known to people skilled in the art and related details will therefore not be included in the following description.

In an embodiment of the optical disc drive 100 according to the present invention, the control module 180 and the detailed components in the control module 180 are implemented with hardware structures and devices. Therefore, when the optical disc drive 100 is powered on, the access control unit 182 firstly reads the program code P1 (the firmware of the optical disc drive 100) stored in the non-volatile memory 260, and then loads the program code P1 into the memory 240. Next, the micro-controller 160 starts to execute the program code P1. In an embodiment, before the program code P1 is executed, a debugging unit 184 can check if the data loaded into the memory 240 is correct according to an error check code of the program code P1. If the check result shows that the data loaded into the memory 240 is correct, the micro-controller 160 will start to execute the program code P1, and then the micro-processor 160 can further drive the RF circuit controller 140 to control the RF circuit 120 to access data stored on the optical disc or to perform other functions. If the check result shows that the data loaded into the memory 240 is incorrect, the debugging unit 184 will notify the updating unit 186 to perform a firmware updating procedure, which means the program code P1 is updated by the updating unit 186. A detailed description of the firmware updating procedure will be described in the following.

In another embodiment, the control module 180 and the detailed components of the control module 180 can be implemented with a program code stored in an embedded boot read-only memory (ROM). Hence, when the optical disc drive 100 is powered on, the micro-processor 160 executes the program code which is stored in the embedded boot ROM and corresponds to the access control unit 182 to transfer the program code P1 stored in the non-volatile memory 260 into the memory 240. The micro-controller 160 then executes the program code which corresponds to the debugging unit 184 and is stored the embedded boot ROM to check if the program code P1 written into the memory 240 is correct according to the error check code of the program code P1 of the non-volatile memory 260. If the check result shows that the program code P1 is correct, the micro-processor 160 is notified to execute the program code P1; otherwise the micro-processor 160 starts to execute a program code corresponding to the updating unit 186 to execute a firmware updating procedure.

In an embodiment, the program code P1 stored in the non-volatile memory 260 can be a compressed file. After the program code P1 is moved into the memory 240, it needs to be decompressed and then executed. In this way, the required memory space of the non-volatile memory 260 can be substantially smaller.

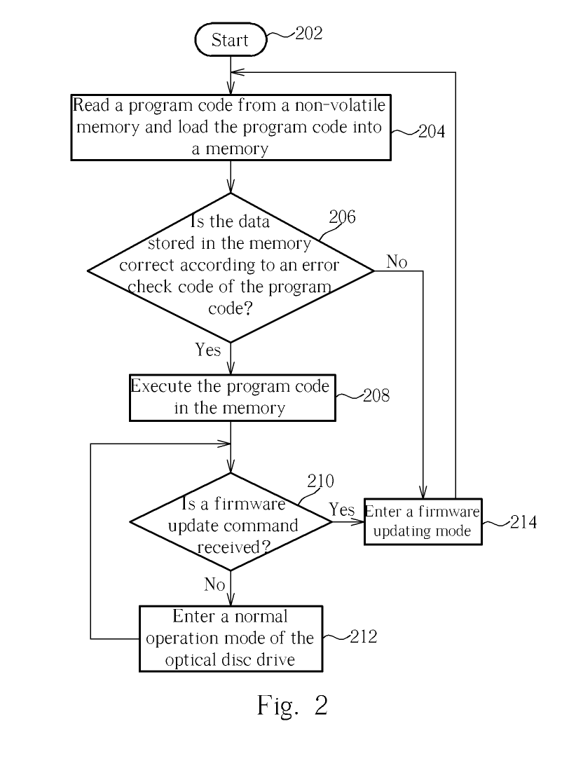

FIG. 2 is a flowchart of updating a program code (a firmware of the optical disc drive) of the optical disc drive according to the present invention. The method includes:

Step 202: Start.

Step 204: Read a program code P1 from a non-volatile memory and load the program code P1 into a memory.

Step 206: Check if the data stored in the memory is correct according to an error check code of the program code P1. If yes, proceed to step 208; otherwise, proceed to step 214.

Step 208: Execute the program code P1 in the memory.

Step 210: Is a firmware update command received? If yes, proceed to step 214; otherwise, proceed to step 212.

Step 212: Enter a normal operation mode of the optical disc drive and go back to step 210.

Step 214: Enter a firmware updating mode; once the firmware updating mode has been completed, go back to step 204.

Therefore, the updating unit 186 is notified to enter the firmware updating mode not only when the debugging unit 184 detects that the firmware loaded into the memory 240 is incorrect (step 214), but also when the optical disc drive 100 sends a firmware update command to the updating unit 186 (step 210).

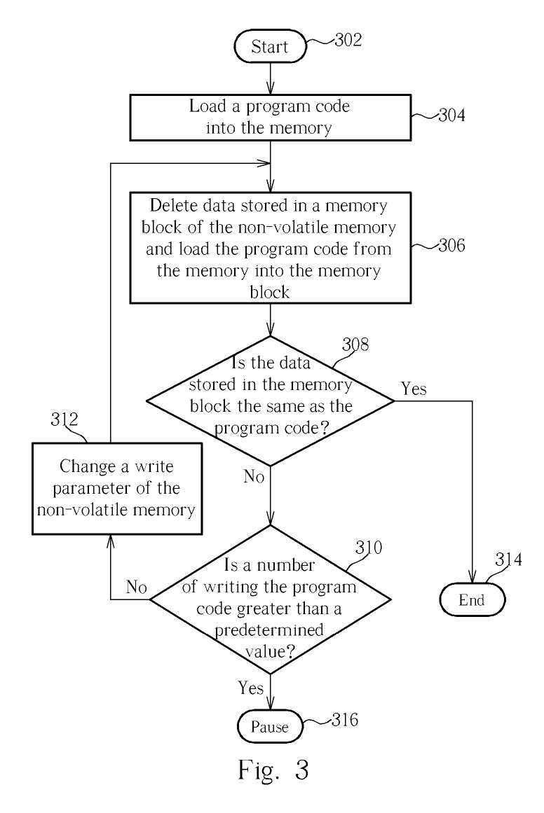

FIG. 3 is a detailed flowchart of step 214 shown in FIG. 2 (the step of executing the firmware updating mode). Step 214 includes:

Step 302: Enter the firmware updating mode.

Step 304: Load the program code P2 into the memory 240.

Step 306: Delete data stored in a memory block of the non-volatile memory 260 and load the program code P2 from the memory 240 into the memory block of the non-volatile memory 260.

Step 308: Is the data stored in the memory block the same as the program code P2? If yes, proceed to step 314; otherwise, proceed to step 310.

Step 310: Record a number of writing the program code P2 and determine if the number of writing the program code P2 is greater than a predetermined value. If yes, proceed to step 316; otherwise, proceed to step 312.

Step 312: Change a writing parameter of the non-volatile memory 260 and repeat the execution of step 306.

Step 314:End.

Step 316: Pause the execution of the firmware updating mode.

Firstly, the updating unit 186 loads the program code P2 from a firmware source (i.e. a hard disk; diskette; CD-ROM) into the memory 240. After checking that the data (the program code P2) stored in the memory 240 according to the error check code of the program code P2 is correct, the updating unit 186 then deletes the data stored in the memory block 262 of the non-volatile memory 260 and loads the program code P2 from the memory 240 into the memory block 262 of the non-volatile memory 260. It should be noted that in the present embodiment, the program code P2 is an independently executable machine code and therefore the program code P2 can be utilized for replacing the program code P1. However, when the content of the program code P2 is only related to some parameters of the optical disc drive, according to the present invention, the principal part of the program code P1 can be kept by deleting data stored in the memory block 264 and loading the program code P2 into the memory block 264 to update a part of system parameters of the program code P1.

Next, the updating unit 186 verifies whether the data stored in the memory block 262 (or in the memory block 264) is the same as the program code P2 stored in the memory 240. If the verification result shows that the data stored in the memory block 262 (or the memory block 264) is the same as the program code P2, the firmware updating mode is ended and the flow proceeds back to the step 204 shown in FIG. 2. Otherwise, the updating unit 186 further determines whether the number of writing the program code P2 into the memory block 262 (or the memory block 264) is greater than a predetermined value. If the number of writing the program code P2 is greater than the predetermined value, the steps of repeatedly writing are paused in order to avoid shortening the life of the non-volatile memory 260. Otherwise, the updating unit 186 can change the writing parameter(s) of the non-volatile memory 260 (for example: extending the write time to reduce the error rate). The updating unit 186 then deletes data stored in the memory block 262 (or in the memory block 264) again and loads the program code P2 into the memory block 262 (or in the memory block 264).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical disc drive, comprising:
a non-volatile memory for storing a first program code;
a memory for providing a memory space needed when executing the first program code; and
a control module coupled to the non-volatile memory and the memory for transferring the first program code of the non-volatile memory into the memory and updating the first program code stored in the non-volatile memory using a second program code when the first program code stored in the memory is correct.

2. The optical disc drive of claim 1, wherein the first program code is a compressed file, and the control module decompresses the compressed file into the memory.

3. The optical disc drive of claim 1, wherein the control module comprises:
an access control unit for writing the first program code stored in the non-volatile memory into the memory and writing the second program code into the non-volatile memory to replace the first program code.

4. The optical disc drive of claim 3, wherein the access control unit adjusts a writing parameter of the non-volatile memory according to a number of writing the second program code into the non-volatile memory.

5. The optical disc drive of claim 3, wherein the control module further comprises:
a debugging unit for checking if the first program code written into the memory is correct;
wherein the access control unit writes the second program code into the non-volatile memory when the first program code written into the memory is correct.

6. The optical disc drive of claim 5, wherein when the first program code written into the memory is incorrect, the access control unit rewrites the second program code into the non-volatile memory, and verifies if the data stored in the non-volatile memory is the same as the second program code.

7. The optical disc drive of claim 6, wherein if the number of rewriting the second program code into the non-volatile memory is greater than a predetermined value, the access control unit stops rewriting the second program code into the non-volatile memory.

8. The optical disc drive of claim 1, wherein the access speed of the memory is greater than that of the non-volatile memory.

9. A method for updating a first program code stored in a non-volatile memory of an optical disc drive, comprising:
providing a memory for providing a memory space needed when executing the first program code;
transferring the first program code of the non-volatile memory into the memory;
executing the first program code stored in the memory to perform at least one function of the optical disc drive when the first program code stored in the memory is correct; and
updating the first program code stored in the non-volatile memory using a second program code.

10. The method of claim 9, wherein the first program code is a compressed file, and the method comprises:
decompressing the compressed file into the memory.

11. The method of claim 9, further comprising:
determining whether the first program code written into the memory is correct according to an error check code of the first program code.

12. The method of claim 9, wherein the updating step comprises:
when the data stored in the non-volatile memory is not the same as the second program code, writing the second program code into the non-volatile memory.

13. The method of claim 12, further comprising:
when the number of writing the second program code into the non-volatile memory is greater than a predetermined value, stopping rewriting the second program code into the non-volatile memory.

14. The method of claim 12, wherein the updating step comprises:
adjusting a writing parameter of the non-volatile memory.

15. The method of claim 9, wherein the memory is a volatile memory.

16. An optical disc drive, comprising:
a non-volatile memory for storing a first program code;
a memory for providing a memory space needed when executing the first program code;
a control module coupled to the non-volatile memory and the memory for transferring the first program code of the non-volatile memory into the memory; and
a controller coupled to the control module for executing the first program code of the memory to perform at least one function of the optical disc drive when the first program code stored in the memory is correct.

17. The optical disc drive of claim 16, wherein the—control module comprises:
an access control unit for writing the first program code stored in the non-volatile memory into the memory and writing the second program code into the non-volatile memory.

18. The optical disc drive of claim 17, wherein the access control unit adjusts a writing parameter of the non-volatile memory according to a number of writing the second program code into the non-volatile memory.
